(19) United States
(12) Patent Application Publication
(10) Pub. No.: US 2002/0033832 A1
(43) Pub. Date: Mar. 21, 2002

(54) Method for computer modeling of visual images and wave propagation

(76) Inventor: Rafail Glatman, Houston, TX (US)

Correspondence Address: Bryan L. White, Bracewell & Patterson, L.L.P., PO Box 61389, Houston, TX, 77208-1389, US

(21) Appl. No.: 09/954,885

(22) Filed: Sep. 18, 2001

Related U.S. Application Data
(60) Provisional application No. 60/233,362, filed on Sep. 18, 2000.

(51) Int. Cl. G06K 9/48; G09G 5/00

(52) U.S. Cl. 345/619; 382/199

(57) ABSTRACT

A method for modeling visual images and wave propagation describes a scene mathematically, calculates certain parameters and visibility areas from input data, and traces the passage of wavefronts through the scene. The scene represents a particular configuration of objects having distinct boundaries, such as interfacing strata. Wavefronts are considered to emanate from a particular source, for multiple sources. Each wavefront is subdivided into discrete front elements that impinge on boundary elements, as determined from computed visibility areas. Each front element that impinges on a boundary element is analyzed to determine reflected front elements and refracted front elements. Those front elements are traced to see if they impinge on another boundary element or a receiver. A front element is traced until its energy falls below a threshold or it leaves the scene. Ray paths from each source to each receiver are computed from which wave-related output parameters are computed and displayed.

This application claims the benefit of U.S. Provisional Application No. 60/233,362 filed Sep. 18, 2000.

### BACKGROUND OF THE INVENTION

1. Field of the Invention

This invention relates to methods for computerized modeling, and more particularly to methods for computerized graphics and for modeling wave propagation through various media.

2. Description of Prior Art

There are various prior art methods used to model the propagation of waves through various media. A common method uses ray tracing in which a signal is represented by a set of discrete rays. Each ray travels in the direction of its orientation until it encounters a different medium (impedance). At the interface, a portion of the ray is reflected, and a portion is transmitted (refracted). Thus, the propagation of the signal is followed by tracing the ray path for the initial ray and those rays that are spawned by it.

For example, in a seismic application, a sound wave is initiated and communicated to the earth (e.g., dynamite is detonated in a shallow well bore). The wave is generally considered to propagate through the earth as a (spherical) wavefront, but can be modeled as a set of spherically diverging rays. A given ray travels in a constant direction until it encounters a change in acoustic impedance. The change is usually caused by a change in geologic formation. Depending on the contrast of impedances between the initial medium and the encountered medium, a certain portion of seismic energy is reflected, and a certain portion is transmitted. Both the reflected and refracted waves can be represented by new rays. Thus the signal can be traced by following the ray paths.

The disadvantages of ray tracing, however, include poor resolution of an image, poor computational speed and efficiency, large memory requirements, and difficulties in tracing multiple reflections and refractions.

An alternative method uses solutions to a set of partial differential equations referred to collectively as the wave equation. The wave equation relates the partial derivatives of a function with respect to its spatial coordinates to the second order partial derivative of the function with respect to time. The disadvantages to that method include poor computational speed and efficiency, difficulty in identifying the particular source of the signal received, and difficulty in studying the influence of a particular medium or a particular medium boundary. This method is generally regarded as less suitable for the applications to which the present invention is directed than ray tracing.

### SUMMARY OF THE INVENTION

The present invention uses an innovative method to model visual images and wave propagation. The method describes a scene mathematically, calculates certain parameters and visibility areas from input data, and traces the passage of wavefronts through the scene. The scene represents a particular configuration of physical objects having distinct boundaries, such as interfacing subsurface strata. Wavefronts are considered to emanate from a particular source, for multiple sources. Each wavefront is subdivided into discrete front elements that impinge on boundary elements, as determined from computed visibility areas. Each front element that impinges on a boundary element is analyzed to determine reflected front elements and refracted front elements. Those front elements are traced to see if they impinge on another boundary element or a receiver. A front element is traced until its energy falls below a threshold or it leaves the scene. Ray paths from each source to each receiver are computed from which wave-related output parameters such as amplitude, energy, phase, travel distance, and travel time are computed, stored in computer memory, and displayed.

### BRIEF DESCRIPTION OF THE DRAWINGS

So that the manner in which the described features, advantages and objects of the invention, as well as others which will become apparent, are attained and can be understood in detail, more particular description of the invention briefly summarized above may be had by reference to the embodiments thereof that are illustrated in the drawings, which drawings form a part of this specification. It is to be noted, however, that the appended drawings illustrate only typical preferred embodiments of the invention and are therefore not to be considered limiting of its scope as the invention may admit to other equally effective embodiments.

In the drawings:

FIG. 1 is a high-level flowchart showing the processing flow in accordance with one embodiment of the present invention.

FIG. 2 is a detailed flowchart showing the processing flow within the Scene Description portion of FIG. 1.

FIG. 3 is a detailed flowchart showing the processing flow within the Source/Receiver Information Processing portion of FIG. 1.

FIG. 4 is a detailed flowchart showing the processing flow within the Visibility Area Calculation portion of FIG. 1.

FIG. 5 is a detailed flowchart showing the processing flow within the Front Tracing portion of FIG. 1.

FIG. 6 is an illustrative example showing a conflict between the media over a particular portion of a boundary element.

FIG. 7 is an illustrative example showing a conflict between the media as observed from a source point.

FIG. 8, having parts (a), (b), (c), and (d) is an illustrative example showing different categories of visibility types.

FIG. 9 is an illustrative example showing the visibility ranges of one boundary element (element 2) relative to another boundary element (element 1).

FIG. 10, having parts (a), (b), and (c), is an illustrative example showing three examples of partial overlap and screening among boundary elements.

### DETAILED DESCRIPTION

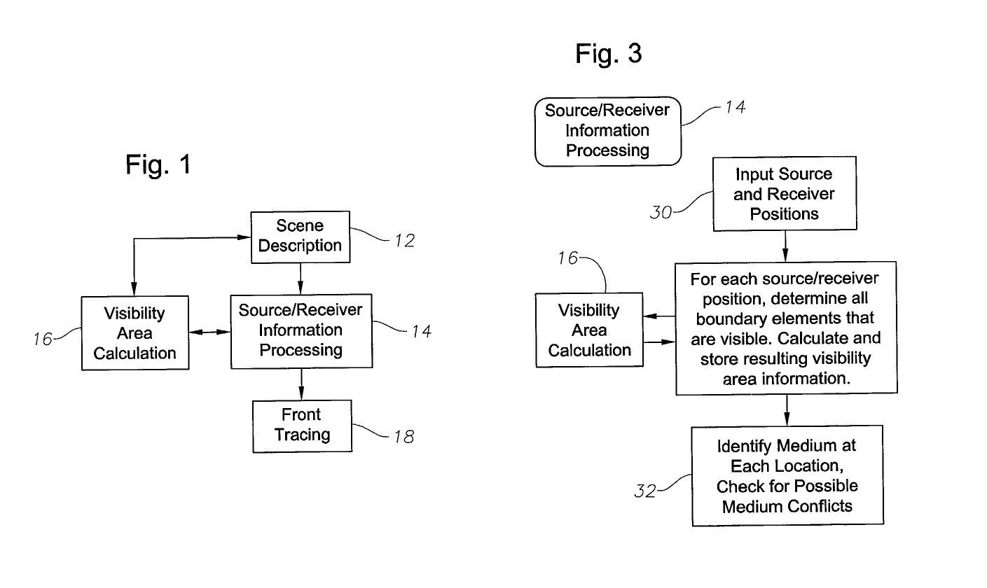

FIG. 1 shows an embodiment of a method 10 for computer modeling of visual images and wave propagation for use on a digital processor computer (not shown) in accordance with the present invention. The method 10 can be generally described by the four main processing steps shown: (1) a Scene Description 12; (2) a Source/Receiver Information Processing 14; (3) a Visibility Area Calculation 16; and (4) a Front Tracing 18. The vertical flow path from the Scene Description 12, to the Source/Receiver Information Processing 14, to the Front Tracing 18 shows the primary processing flow to obtain the desired output from the input parameters. The double-headed arrows between the Visibility Area Calculation 16 and the Scene Description 12, and between the Visibility Area Calculation 16 and the Source/Receiver Information Processing 14, show that information is separately provided to the Visibility Area Calculation 16 by the Scene Description 12 and the Source/Receiver Information Processing 14, respectively, and the Visibility Area Calculation 16 returns processed information to those respective portions of method 10.

For ease of discussion, the embodiments described shall be directed toward geophysical applications, but the invention is not limited to such. It can also be applied, without limiting the invention's scope in any way, to situations in which electromagnetic waves propagate, such as in optics or computer graphics.

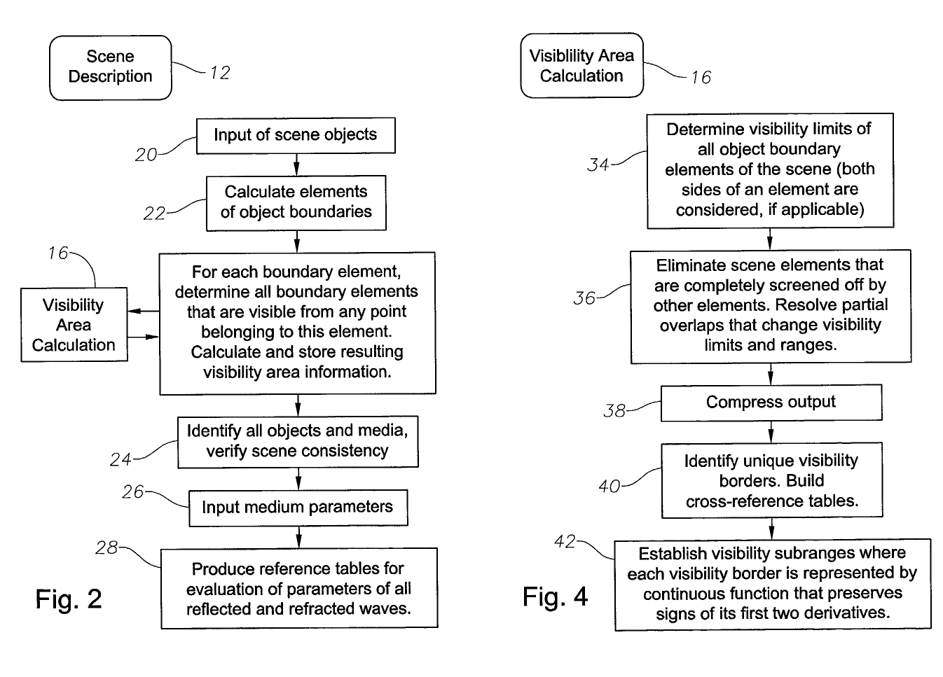

The primary purpose of the Scene Description 12 (FIG. 2) is to produce the visibility information for all parts of all objects of the scene. A secondary purpose is to produce reference tables used to evaluate the parameters of the reflected and refracted waves based on user-defined input parameters and object boundary information. The user may provide object boundary information in various ways: for example, either on a point-by-point basis or using analytical functions. The boundaries may be 2-D objects or 3-D objects. This step corresponds to the Input of Scene Objects 20 shown in FIG. 2. In the step Calculate Elements of Object Boundaries 22, the input boundary information is transformed so that the boundary elements are represented as a set of third-degree polynomials or as circular or spherical segments, depending on the shape of the boundary. That can be accomplished using such methods as cubic-spline interpolation or series expansion. The boundary elements are subdivided in such a way that the first and second derivatives for each element preserve sign. Special attention must be devoted to those 3-D cases in which a saddle point is encountered.

For each boundary element, all boundary elements visible from any point on that particular boundary element are determined. That is accomplished using the Visibility Area Calculation 16, the details of which will be described below. The resulting visibility information is stored in the computer's memory.

Based on object boundary and visibility information, all media comprising the objects are identified in the step Identify All Objects and Media, Verify Scene Consistency 24. Each boundary element is assigned two media numbers. Those media numbers identify each medium on either side of the boundary. Corresponding sides of all boundary elements visible from the same side of a particular boundary are assigned the same medium number. Also in that step, the various media are checked for distinctness to insure there are no inconsistencies. That is, a check is performed to see if any particular medium (i.e., the same area or volume) has been assigned more than one medium identification number. If such a nonphysical discrepancy is found, as in FIG. 6, processing is aborted and error messages are sent to the user. In FIG. 6, the segment on boundary A indicated with a brace has a media conflict because both sides of boundary B, which separates distinct media M1 and M2, are directly visible from any point on that segment.

In the step, Input Medium Parameters 26, the user may input physical parameters for the different media such as density, longitudinal wave velocity, and transverse wave velocity. Such information is used to compute quantities such as acoustic impedance, reflection coefficients, and other wave propagation parameters.

Produce Reference Tables for Evaluation of Parameters of all Reflected and Refracted Waves 28 is the step that generates and stores in computer memory the desired tabular output based on the various user input under the Scene Description 12. The total number of adjoining medium combinations is determined, and a special reference table is produced for each combination. The table contains a comprehensive evaluation of amplitudes, energies, and phases of the resulting waves as a function of the incidence angle of the wave that hits a boundary having particular medium properties on both sides. Those areas in which the parameters of the resulting waves change rapidly (e.g., near the total reflection angle) are analyzed with particular care.

The step Source/Receiver Information Processing 14 (FIG. 3) comprises two main steps. In the first, the Input Source and Receiver Positions 30 step, the user provides geometry information to specify the locations of the source and various receivers. The source and receiver locations are arbitrary. For the given source location, all areas visible from that location are determined. Similarly, for each receiver location, all object boundaries visible from that receiver location are identified. In all cases, those visibility determinations are made using the Visibility Area Calculation 16. As before, the resulting visibility information is stored in computer memory.

In the second main step, Identify Medium at Each Location, Check for Possible Medium Conflicts 32, a consistency check similar to that described above is performed. Based on input geometry, object boundaries, and visibility information, the various media are again checked for distinctness to insure there are no inconsistencies. If a nonphysical discrepancy is found, as in FIG. 7, processing is aborted and error messages are sent to the user. FIG. 7 shows a situation in which two distinct media are directly visible from a source point. If no such discrepancies are found, information about the visibility of each receiver from each boundary from which that particular receiver is visible is computed and stored in computer memory.

The Visibility Area Calculation 16 (FIG. 4), as mentioned above, is used in the Scene Description 12 and the Source/Receiver Information Processing 14 to obtain visibility information. For each side of each boundary element, all visible elements are determined. Certain boundary elements may have objects visible from one side only, while others may have objects visible from both sides. Thus, for each element that is visible from some particular element, the coordinate range over which each side of the element is visible is determined. This includes the case in which the visible element and the particular element are the same, such as when an observer on a curved element looks across the concave interior and views another portion of that same curve. Those determinations are made in the step Determine Visibility Limits of All Object Boundary Elements of the Scene 34, as shown in FIG. 4.

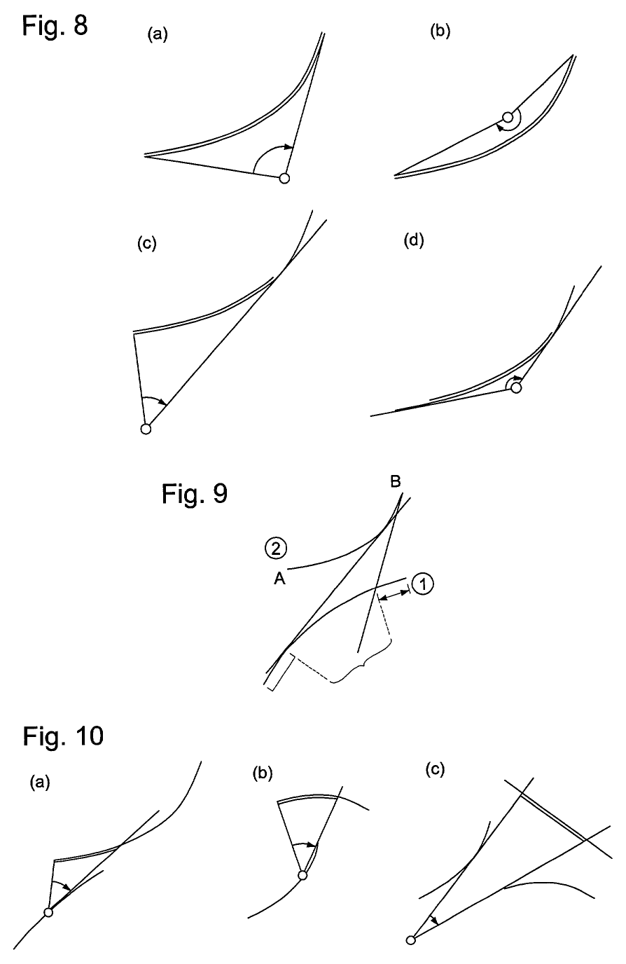

Also in that step, the visibility type is determined. The visibility type is categorized as either: (1) endpoint-to-endpoint; (2) endpoint-to-tangent; or (3) tangent-to-tangent. The visibility type indicates the nature of the limitation on the range of visibility (e.g., an endpoint or a point of tangency). Illustrative examples are shown in FIG. 8. In each of the four examples shown, the small open circle represents an observation point (e.g., a source or a receiver) and the line segments extending from the observation point to the curve segment represent visibility borders. FIGS. 8(a) and 8(b) show visibility ranges bounded by the endpoints of the convex and concave curve segments, respectively. In both of those examples, the entire curve segments are visible from the observation point. FIG. 8(c) shows a visibility range bounded by an endpoint of the curve segment and the point on the curve segment at which a line segment passing through the observation point is tangent to the curve. The remaining portion of the curve segment beyond the tangent point is obscured from the view of the observer. FIG. 8(d) shows an example in which the visibility range is bounded by two points of tangency. As before, each tangent line passes through the observation point and is tangent to the curve. Those portions of the curve beyond the tangency points are obscured from view. The visible portions are indicated by a parallel, adjacent curve segment.

As a further example of determining visibility ranges, FIG. 9 shows the visibility ranges of one boundary element (element 2) relative to another boundary element (element 1). There are three resulting ranges. In one range, marked with a bracket on FIG. 9, the visible portion of element 2 is limited by the endpoint A and the point of intersection on element 2 with the tangent to element 1 through the current observation point. In a second range, marked with a brace on FIG. 9, the visible portion of element 2 extends from the endpoint A to the point of tangency on element 2 passing through the current observation point on element 1. In the final range, marked with a double-headed arrow on FIG. 9, the entire boundary element from A to B is visible.

Because certain portions of scene elements may be obscured from view, the Visibility Area Calculation 16 includes the step Eliminate Scene Elements that Are Completely Screened Off by Other Elements, Resolve Partial Overlaps that Change Visibility Limits and Ranges 36. FIG. 10 shows three illustrative examples. In each of the examples, the open circle represents the current observation point, whether a boundary point, a source point, or a receiver point. In FIGS. 10(a) and 10(b), the view of the observer is obscured by the current element itself (i.e., the boundary element on which the observation point is located). In FIG. 10(c), the observer's view is obscured by other elements, unrelated to the observer. In each case, the screened visibility ranges are limited by endpoints or tangents of the screening element. The visible portions are indicated by a parallel, adjacent curve segment. Again, the visibility borders are the line segments extending from the observation point to the curve segment.

Determining the reduced visibility ranges allows the user to perform the step Compress Output 38. This conserves computer memory by releasing the memory locations storing information about the screened elements that are no longer needed. Further economy is gained by the step Identify Unique Visibility Borders, Build Cross-Reference Tables 40. While certain visibility borders are unique, others are common to several visibility areas. A cross-reference table identifies those shared borders and such border information need be stored only once in computer memory.

Each of the resulting visibility borders can be expressed as a function of the coordinates used to define the element boundaries. Specifically, the visibility borders are expressed as a tangent or cotangent of the angle formed by the border and the reference axis. Each of those functions is differentiated to determine its first and second derivatives. Those derivatives are then analyzed to determine extrema points, inflection points, and saddle points. Visibility border discontinuities are also determined. If any of those special points are found, the corresponding visibility range is subdivided until each resulting visibility subrange can be represented by a continuous, monotonic function with only one type of curvature. Such subdivision is done to make the anticipated computation of intersection points with any wave front quick and reliable. All this is done in the Establish Visibility Subranges Where Each Visibility Border Is Represented by Continuous Function that Preserves Signs of Its First Two Derivatives 42. Those continuous, monotonic functions with only one type of curvature are the output from that step.

For an application involving computer graphics, because the surface interpolation and front element interpolation are obtained analytically and with high precision, fast and effective calculation of the intensity of reflected light, and therefore, of shading, shadowing, and color, can be accomplished to produce high quality visual displays of the various objects in the scene.

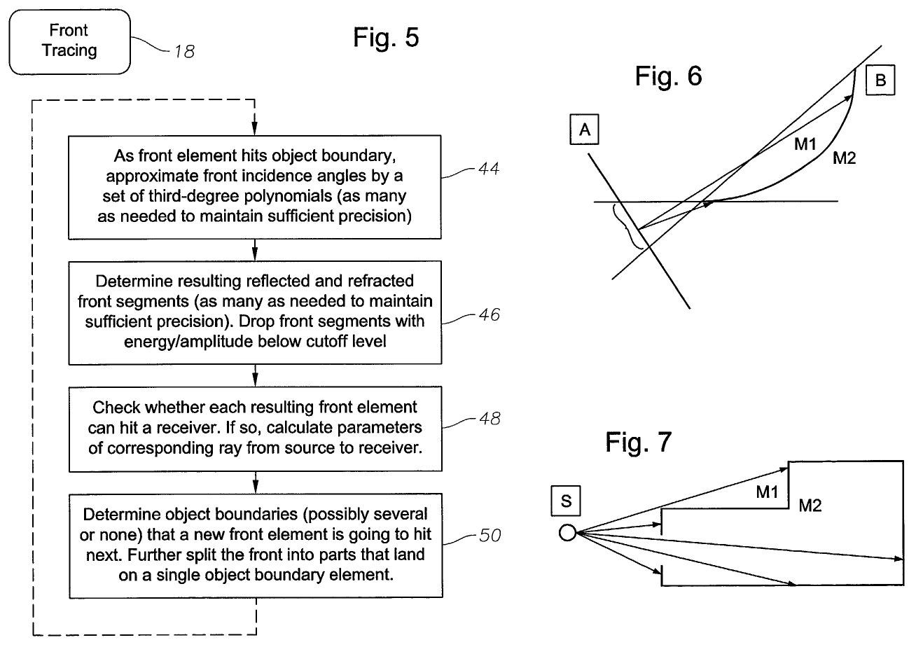

In the Front Tracing 18 step (FIG. 5), a wavefront emanating from a source point is traced through the various media until it either leaves the scene or its energy diminishes below a user-defined threshold. For those portions of the wavefront that hit a receiver, information about the wave at that point, such as its amplitude, energy, phase, travel distance, and travel time is calculated and stored in computer memory, and displayed to the user. To perform the Front Tracing 18, a check is made to determine if there are any direct paths between the source and the receivers. In addition, the initial and subsequent reflected and transmitted wavefronts are each subdivided into front elements that will impinge on those (individual elements of) object boundaries that are visible from the source location. For each subdivided front element, the projection of the incident front element onto the current boundary element is determined. If necessary, the original front element is further subdivided so that the projection of each new sub-element can be approximated with sufficient precision by a third-degree polynomial relating front incidence angles with the boundary primary coordinates. FIG. 5 shows this as the step As Front Element Hits Object Boundary, Approximate Front Incidence Angles by a Set of Third Degree Polynomials 44.

For each approximated incident wave element, the resulting reflected and refracted front elements are determined in the step Determine Resulting Reflected and Refracted Front Segments 46. If necessary, the resulting front elements are further subdivided, as above, to insure sufficient precision. Using the reference tables for the corresponding medium combinations and angular ranges, the energy of each of the resulting waves is quickly ascertained. If the energy level of a particular front element is below the user-defined threshold, that front element is not considered further. Alternatively, a user can define a maximum number of reflections which a front element can undergo. Upon undergoing that maximum number of reflections, that particular front element is not considered further. Either incidence angles or boundary primary coordinates will be used as arguments in the polynomial representation of a particular front element to obtain the best approximation.

The remaining front elements are further processed using the step Check Whether Each Resulting Front Element Can Hit a Receiver 48, as shown in FIG. 5. Using the receiver visibility information, each remaining front element is analyzed to determine which, if any, can possibly hit a receiver. For those that will impinge on a receiver, the corresponding ray path from source to receiver is determined. To increase the robustness of the results, the reverse ray path from the receiver to the source is independently determined. If the reverse ray path does not pass sufficiently close to the source, the direction of the initial ray is modified slightly to produce a more correct ray path. Using the corrected ray path information, the amplitude, the energy, the phase, the travel distance, and the travel time are computed and stored in computer memory, and displayed to the user.

Using the visibility information for the boundary element from which a new front element originates, object boundaries that lie in the path of the new front element are identified. There may be several or none. As the front elements propagate, they tend to leave the scene entirely or carry insufficient energy. If more than one object boundary is identified, the front element is subdivided so that each subdivided front element impinges on only one object boundary element. This portion of the process is represented in FIG. 5 by the step Determine Object Boundaries that a New Front Element Is Going to Hit Next 50.

The steps represented by figure elements 44, 46, 48, and 50 in FIG. 5 are repeated until all front elements either leave the scene or drop below the energy threshold.

The present invention offers many advantages over the prior art. A full scene description is obtained that can be used repeatedly for different source and receiver configurations. The method permits high precision because represented elements can be subdivided until adequate precision is obtained. Also, continuous front elements are traced, not rays, as they propagate to and through precise boundaries. Hence, because the likelihood of computational discontinuities is greatly reduced, it is less likely that a ray that actually hits a receiver is missed.

The method permits investigation of wavefronts that impinge nearly tangentially to a boundary. Unlike solutions based on the wave equation, each signal registered by a receiver can be traced back to the source because each signal's trajectory is identifiable. The method is computationally efficient because as much as possible is determined before tracing the front elements. Memory requirements are much less than alternative methods since only one front element at a time is traced, and though the front element is arbitrarily small, it can be further subdivided at any time in the tracing process to insure adequate precision and to preserve memory. The method easily permits tracing of additional front elements generated by the initial front element, such as may occur as a result of diffraction. If required, the shape of the propagating wavefront can be simply determined at any desired time. This is particularly useful for studying secondary fronts generated by a diffractor or for animation of front propagation. Scene consistency based on input object boundary data, including identification of closed areas and checks for boundary and media conflicts is performed.

While the invention has been particularly shown and described with reference to a preferred and alternative embodiments, it will be understood by those skilled in the art that various changes in form and detail may be made therein without departing from the spirit and scope of the invention.

What is claimed is:

1. A method for modeling visual images and wave propagation, comprising the steps of:
(a) describing a scene mathematically;
(b) processing source and receiver information;
(c) calculating visibility areas;
(d) tracing wavefronts; and
(e) displaying results.

2. The method of claim 1 wherein step (a) further comprises:
inputting boundary information for each object in a scene;
transforming the boundary information to express boundaries as boundary elements in a desired mathematical representation;
determining all boundary elements that are visible from any point on a particular boundary element, for each boundary element;
identifying media on opposite sides of a particular boundary element, for each boundary element;
verifying consistency of the identified media; and
inputting physical parameters of the media.

3. The method of claim 2 further comprising the steps of:
producing reference tables; and
storing in computer memory the reference tables.

4. The method of claim 1 wherein step (b) further comprises:
inputting a source position for all sources;
inputting a receiver position for all receivers;
determining all boundary elements that are visible from a particular source, for each source;
determining all boundary elements that are visible from a particular receiver, for each receiver;
storing in computer memory the determined boundary elements that are visible from a particular source, for each source; and
storing in computer memory the determined boundary elements that are visible from a particular receiver, for each receiver.

5. The method of claim 4 further comprising the step of verifying media consistency of the identified boundary elements.

6. The method of claim 1 wherein step (c) further comprises:
determining visibility limits of all boundary elements that are visible from any point on a particular boundary element, for each boundary element;
determining visibility limits of all boundary elements that are visible from a particular source, for each source;
determining visibility limits of all boundary elements that are visible from a particular receiver, for each receiver;
eliminating from further processing those portions of all boundary elements whose visibility is screened by other boundary elements, relative to any point on a particular boundary element, for each boundary element;
eliminating from further processing those portions of all boundary elements whose visibility is screened by other boundary elements, relative to a particular source, for each source;
eliminating from further processing those portions of all boundary elements whose visibility is screened by other boundary elements, relative to a particular receiver, for each receiver;
determining visibility borders;
subdividing each visibility range into visibility subranges such that the visibility borders of each visibility subrange can be represented by a continuous, monotonic function with only one type of curvature; and
storing in computer memory the visibility subranges.

7. The method of claim 6 further comprising the step of identifying unique visibility borders among all remaining portions of all boundary elements.

8. The method of claim 6 further comprising the step of compressing the visibility limit data stored in computer memory to save memory space.

9. The method of claim 6 further comprising the step of building cross-reference tables.

10. The method of claim 1 wherein step (d) further comprises for each source:
(i) determining if there are any direct paths between a particular source and the receivers;
(ii) subdividing an initial wavefront emanating from the particular source into front elements such that a particular front element impinges on a particular boundary element that is visible from the particular source;
(iii) determining a projection of the particular front element onto the particular boundary element, for each front element;
(iv) determining reflected front elements, for each front element;
(v) determining refracted front elements, for each front element;
(vi) determining whether any of the reflected or refracted front elements impinge on any of the receivers;
(vii) determining a particular ray path between a particular receiver and the particular source, for each front element that impinges on any of the receivers;
(viii) computing physical parameters based on the particular ray path, for each particular ray path;
(ix) storing in computer memory the computed physical parameters;
(x) determining all boundary elements on which the reflected and refracted front elements emanating from the particular boundary element will impinge, for each front element;
(xi) subdividing the reflected and refracted front elements that impinge on more than one boundary element into subdivided front elements such that each subdivided front element impinges on a single boundary element; and
(xii) repeating steps (iii)-(xii) using a particular subdivided front element and its associated boundary element instead of the particular front element and the particular boundary element, for each subdivided front element, until all subdivided front elements are either eliminated or no longer impinge on any boundary.

11. The method of claim 10 further comprising the steps of:
determining whether the reflected front elements or the refracted front elements have less energy than a comparison value, for each reflected front element and each refracted front element; and
eliminating from further processing each reflected front element and each refracted front element having less energy than the comparison value.

12. The method of claim 10 further comprising the step of eliminating from further processing each reflected front element that has undergone a user-defined number of reflections.

13. The method of claim 10 further comprising the steps of:
determining a particular reverse ray path from the particular receiver to the particular source to verify that the particular reverse ray path terminates within a tolerance value at the particular source, for each of the particular ray paths; and
computing a modified particular reverse ray path for each particular reverse ray path that does not fall within the tolerance value at the particular source until the modified particular reverse ray path terminates within the tolerance value at the particular source.

14. A method for modeling visual images and wave propagation, comprising the steps of:
(a) describing a scene mathematically;
(b) processing source and receiver information;
(c) calculating visibility areas;
(d) interpolating front elements analytically;
(e) tracing wavefronts; and
(f) displaying results.

15. The method of claim 14 further comprising the step of determining intensity of a reflection.

16. The method of claim 15 further comprising the step of determining shading.

17. The method of claim 15 further comprising the step of determining shadowing.

18. The method of claim 15 further comprising the step of determining color.
